(19) United States
(12) Patent Application Publication
(10) Pub. No.: US 2014/0222496 A1
(43) Pub. Date: Aug. 7, 2014

(54) DETERMINING COST AND RISK ASSOCIATED WITH ASSETS OF AN INFORMATION TECHNOLOGY ENVIRONMENT

(71) Applicant: INTERNATIONAL BUSINESS MACHINES CORPORATION, Armonk, NY (US)

(72) Inventors: Romelia H. Flores, Keller, TX (US); Joseph E. Hackett, Fort Worth, TX (US); Leonard S. Hand, Red Creek, NY (US)

(73) Assignee: International Business Machines Corporation, Armonk, NY (US)

(21) Appl. No.: 13/761,402

(22) Filed: Feb. 7, 2013

(51) Int. Cl. G06Q 10/06

(52) U.S. Cl. CPC G06Q 10/0635
USPC 705/7.28

(57) ABSTRACT

A computer determines the cost and risk of assets. The computer analyzes an asset signature, associated with an asset representing a fundamental structural unit of an information technology environment, to determine that the asset is in a non-normal state. The computer determines the cost of the asset by evaluating a price formula associated with the asset signature of the asset, and the computer determines the risk of the asset by evaluating a risk formula associated with the asset signature of the asset. The computer maintains a configuration item for the asset, indicating the state, the risk, and the cost of the asset. One or both of the risk and the cost of the asset are used to determine the priority of recovering the asset.

### FIELD OF THE INVENTION

The present invention relates to the field of change management and, more particularly, to utilizing asset signatures to determine cost and risk of assets within an asset management system.

### BACKGROUND

One challenge faced by change management systems within large and small data centers is the identification of and subsequent relinquishment of unused, or “derelict,” assets. Traditionally, when primary assets (e.g., servers, platforms, software, etc.) are provisioned, additional assets associated with security, data, and enablement can also be provisioned during this process in support of the primary assets. Many of these additional assets cannot be tracked and/or linked to the primary assets. The challenge is further compounded when a data center expands by adding new assets. While feedback mechanisms exist to manage provisioned assets, the additional assets can go unmanaged. Consequently, server sprawl and other less than optimal situations can result, and in certain circumstances the additional assets can go unused.

When it is necessary to relinquish the provisioned primary asset, the primary asset can either be retired or reused. However, all additional assets can typically continue to use resources (e.g., memory, disk space, processor load, etc.) in the data center. Security risks can occur as a result of the existence of these derelict additional assets. For example, when an additional asset such as a “pinhole” is utilized within a firewall to permit access to the primary asset, the pinhole can remain after the primary asset is retired. While conventional systems can discover assets and track assets throughout the asset lifecycle, these systems cannot manage additional assets which typically have relationships to the provisioned primary assets that are generalized, obscure, and/or undefined via their tooling. That is, conventional change management systems fall short when these relationships deal with infrastructure modifications.

Further, the consequences of the existence of a derelict asset are not known by conventional change management systems. For example, given a particular derelict asset, a conventional change management system does not include a representation of the cost associated with the derelict asset or the risk associated with the derelict asset. Derelict assets typically pose a security risk/liability, operational cost or both. Even data centers that are aware of derelict assets typically do not have visibility to the operational and liability costs associated with these assets.

### SUMMARY

Embodiments of the present invention provide for a program product, system, and method to determine the cost and risk of assets. A computer analyzes an asset signature, associated with an asset representing a fundamental structural unit of an information technology environment, to determine that the asset is in a non-normal state. The computer determines the cost of the asset by evaluating a price formula associated with the asset signature of the asset, and the computer determines the risk of the asset by evaluating a risk formula associated with the asset signature of the asset. The computer maintains a configuration item for the asset, indicating the state, the risk, and the cost of the asset. One or both of the risk and the cost of the asset are used to determine the priority of recovering the asset.

### BRIEF DESCRIPTION OF THE SEVERAL VIEWS OF THE DRAWINGS

FIG. 1 depicts a system for asset signatures which are able to determine cost and risk of derelict assets of an IT environment in accordance with an embodiment of the present invention.

FIG. 2 depicts a graphical interface for displaying cost and risk of derelict assets of an IT environment in accordance with an embodiment of the present invention.

FIG. 3 depicts a flowchart illustrating steps followed by an asset management system during the determination of the cost and risk of derelict assets of an IT environment in accordance with an embodiment of the present invention.

FIG. 4 is a functional block diagram of a computer system in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Many information technology (IT) environments exist (e.g., data centers, etc.), where dynamic changes (e.g., additions, changes, deletions) of IT assets are expected. The number of dynamic changes is continuously increasing, as more cloud based solutions, which include remotely hosted solutions, are becoming more common. A significant number of IT assets are provisioned in an IT environment, but are not initially tracked by an asset management system, and which thereby need to be discovered by an asset management system. Discovery of assets can be performed according to techniques discussed in, for example, U.S. Patent Pub. No. 2012/0297053 A1. Such a solution can also provide feedback to an asset management system to improve the accuracy of maintained configuration item relationships. An asset state can have multiple dimensions that are relevant at various points in time, that have elements that need to occur over time, and that have elements that must evolve over time.

An asset management system can establish a set of asset signatures with an ability to be customized with ongoing detection of signature updates. The asset signatures can be analyzed to discover derelict signatures which indicate a statistically significant probability that the corresponding asset is a non-normal asset, being in one of several derelict states. In one embodiment, a multi-phased approach can be taken, where suspect assets can be initially identified so that a more detailed discovery and analysis can be performed on this subset of assets. This type of multi-phased screening can ensure implementation of the asset signatures and related functionality can occur with minimal impact on runtime performance and minimal consumption of computing resource of the IT environment. After determining a non-normal (e.g., derelict, etc.) asset, the derelicts cost and risk can also be determined.

As disclosed herein, each asset signature can include state elements supporting multiple states, data gathering elements, and a set of one or more formulas, each having customizable threshold triggers. The formulas can include, for example, a signature evaluation formula, a signature status formula, a cost formula, and a risk formula, each with their own set of one or more triggers. The signature evaluation formula and the signature status formula can work together to enhance and detect a derelict asset. The cost formula and the risk formula can work together to determine the cost and risk of a derelict asset. These formulas can be asset-specific, so that different types of assets and different specific assets provisioned in an IT environment can have their own customized formulas.

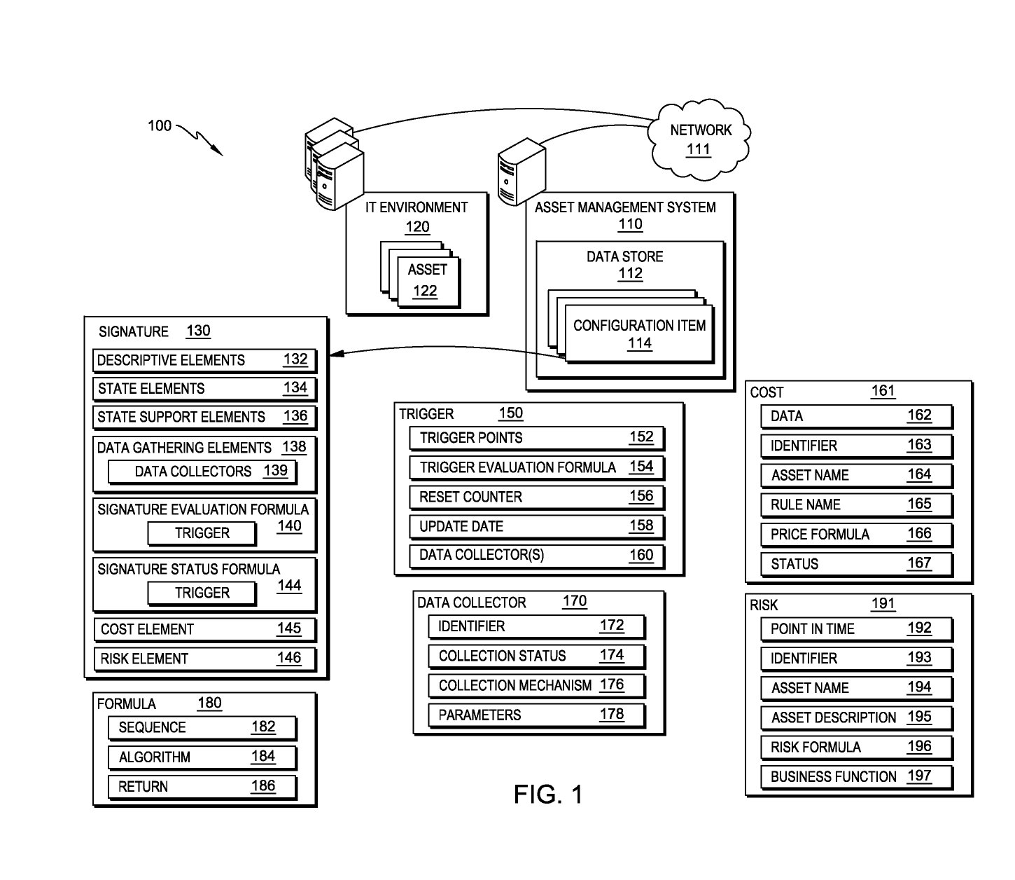

FIG. 1 is a schematic diagram illustrating system 100 for asset signatures which are able to determine cost and risk of derelict assets of an information technology (i.e., “IT”) environment in accordance with an embodiment of the present invention. System 100 includes IT environment 120 and asset management system 110, connected via network 111. Network 111 can be, for example, a local area network (LAN), a wide area network (WAN) such as the Internet, or a combination of the two, and can include wired or wireless connections. In general, network 111 can be any combination of connections and protocols that will support communications via various channels between IT environment 120 and asset management system 110 in accordance with an embodiment of the invention.

IT environment 120 includes IT assets 122, as discussed below, and asset management system 110 can manage assets 122 of IT environment 120. Assets 122 can have corresponding configuration items 114, which are stored in data store 112. Each configuration item 114 can include an asset signature 130. In other words, each of configuration items 114 can be indexed to a unique asset signature 130.

Each asset signature 130 can include one or more formulas (e.g., having a structure as shown by formula 180, etc.), such as signature evaluation formula 140, signature status formula 144, price formula 166, and risk formula 196 (the latter two stored within cost element 145 and risk element 146, respectively). Each of these formulas 140, 144, 166, and 196 of asset signature 130 can be associated with one or more customizable triggers 150. Triggers can include their own formulas 154 (e.g., having a structure as shown by formula 180, etc.). Signatures 130 and triggers 150 can also have one or more data collectors 139, 160 (e.g., having a structure as shown by data collector 170, etc.). The asset signatures 130 are sophisticated and tailored objects having an ability to be easily customized with ongoing detection functions and capable of being easily updated as situations of use change. Further, in one embodiment the asset signatures 130 are sophisticated and tailored objects having an ability to be easily customized with cost and risk determination functions.

IT environment 120 includes hardware and/or software components that functionally interact with each other. IT environment 120 can include one or more discrete machines (computers, servers, peripherals, storage devices), which execute software and firmware. In one embodiment, IT environment 120 can include all equipment and software of a data center. Additionally, a distributed data center consisting of two or more linked data centers, which are together managed by the asset management system 110 can be considered an IT environment, as defined herein.

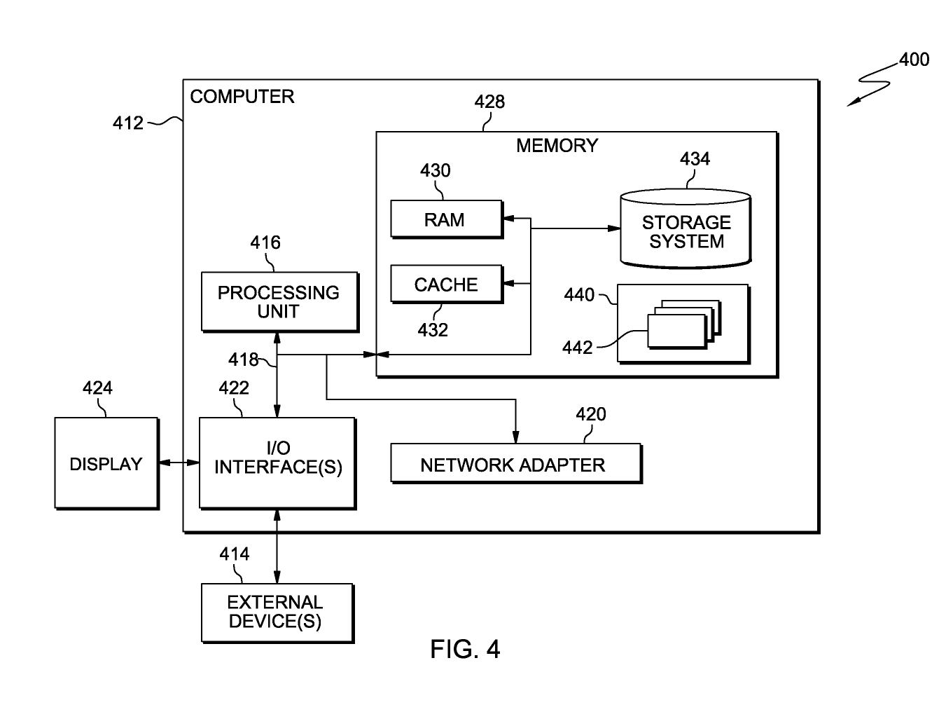

In various embodiments, asset management system 110, as well as one or more of assets 122 in IT environment 120, can include a laptop, tablet, or netbook personal computer (PC), a desktop computer, a personal digital assistant (PDA), a smart phone, a mainframe computer, or a networked server computer. Further, asset management system 110 and one or more of assets 122 in IT environment 120 can be computing systems utilizing clustered computers and components to act as single pools of seamless resources when accessed through network 111, or can represent one or more cloud computing datacenters. In general, asset management system 110, as well as one or more of assets 122 in IT environment 120, can be any programmable electronic device as described in further detail with respect to FIG. 4.

An asset 122 can represent a fundamental structural unit of IT environment 120. An asset 122 can correspond to a single configuration item 144 of asset management system 110. In one embodiment, assets 122 can be defined in a nested fashion, so that multiple lower-level assets can be used to form a single higher-level asset. Assets 122 can include software-only assets, hardware-only assets, and hybrid assets including both software and hardware. Further, assets 122 can represent executable sets of computer program instructions, configuration parameters, ports, rules (e.g., a virtual network or VPN rule on an appliance), etc. Assets 122 can be created, released, contained, or destroyed in IT environment 120. Assets 122 can have a state within IT environment 120 that dynamically changes over time.

Asset management system 110 can be a system that manages, tracks, monitors, provisions, releases, etc., assets 122 of IT environment 210. That is, asset management system 110 can perform IT asset management (ITAM) for IT environment 120. Asset management system 110 can be referred to as an asset lifecycle management system, a configuration management system, a change management system, etc. Asset management system 110 can handle asset 122 from acquisition (or creation) through disposal. Asset management system 110 can establish one or more configuration items 114 for each asset 122, which are maintained in data store 112. A state of the configuration item 114 should minor a state of the corresponding asset 122, where an asset's state (and thus the state of the configuration item 114) can dynamically change over time.

Asset signature 130 of a configuration item 114 includes all data and/or formula elements used to identify a corresponding asset 122 (or configuration item 114) as normal or non-normal (e.g., suspect derelict, actually derelict, etc.). The signature 130 can include descriptive elements 132, state elements 134, state support elements 136, data gathering elements 138, and/or formulas 140, 142, 166, and 196.

Descriptive elements 132 refer to items that identity an asset 122 (or configuration item 114). Descriptive elements 132 can include, for example, a unique asset identifier, an asset name, an asset description, an asset type, an asset owner, an asset administrator, an activation date, a template associated with the asset, and the like. State elements 134 can include elements that contain the state of the corresponding asset 122, where state can refer to a status, as well as an evaluation state. States that an asset can be in, which are recorded by the state asset elements 134 can include normal or non-normal (e.g., suspect, derelict delete, derelict contain, and retired, etc.). A normal state can indicate that the asset being leveraged in the IT environment (e.g., a data center) can be operating “normally”. The suspect state can indicate that the asset is suspect as a potential derelict asset. For example, a screening phase for assets can indicate that a significant probability (e.g., a configurable threshold) exists that the asset is derelict. Suspect assets can undergo further analysis, which can determine that the asset is either “normal” or is actually a derelict asset. The derelict delete state can be for assets that have been determined as derelict, where the asset is to be deleted. The derelict contain state is for assets determined as derelict, were some doubt exists about the certainty of deletion. Thus, a mechanism for recovery is provided before the asset is deleted (a derelict contain asset can be recovered, where a derelict delete asset cannot). The retired state indicates that an asset is to be relinquished or retired.

State support elements 136 include a set of items of information that help derive the state (e.g., stored in state elements 134, etc.). State support elements 136 can include, for example, signature points, point threshold, reset counter, state change date, signature evaluation formula 140, signature status formula 144, cost element 145, and risk element 146. Data gathering elements 138 provide information in support of the formulas 140, 144, 166, and 196. Data gathering elements 138 can gather information from one or more identifiable sources, such as Uniform Resource Identifier (URI) addressable sources accessible via the Internet. The data gathering element can include zero or more data collectors 139. Signature evaluation formula 140 can be a point-in-time evaluation of asset 122. The signature status formula 144 can be a time aspect for the signature. Formula 140 and 144 together can determine a current status for the asset 122.

Cost element 145 can be an instance of cost 161. Cost 161 is a data structure, such as an XML DTD, which includes date 162, identifier 163, asset name 164, rule name 165, price formula 166, and status 167. Risk element 146 can be an instance of risk 191. Risk 191 is a data structure, such as an XML DTD, which includes point in time 192, identifier 193, asset name 194, asset description 195, risk formula 196, and business function 197.

A trigger 150 can be associated with each of signature evaluation formula 140, signature status formula 144, price formula 166, and risk formula 196. Trigger 150 can initiate a gathering of relevant data to support the formulas 140, 144, 166, and 196. A particular trigger 150 may operate independent of other triggers 150 or may rely on data combined from one or more other triggers 150 (e.g., dependency relationships can exist among triggers 150, etc.). Trigger 150 can have one or more trigger points 152, trigger evaluation formula 154, reset counter 156, update date 158, and/or one or more data collectors 160. Each trigger point 152 can be used to keep track of a “value” that the trigger is evaluated to. That is, a formula 180 that is associated with a trigger 150 can include one or more unknown values, where each value can correspond to a trigger point 152. Trigger evaluation formula 154 can be an algorithm or procedure that executes for a given trigger point 152 to produce a value. This value can result from information collected by one or more data collectors 160 being combined in accordance with an established mathematical equation. Reset counter 156 can be used to keep track of administrative resets to the trigger points 152. There can be numerous occasions where an administrator will want to reset the formulas based on changes to IT environment 120 or to a corresponding configuration item 114. Administrative resets to trigger points 152 can be automatic based on an occurrence of a set of defined conditions and/or can be manually invoked by an administrator. Update date 158 can be used to keep track of the “freshness” of the trigger state. That is, update date 158 can reflect a date of currency for trigger 150. Some triggers 150 can be configured to execute the trigger evaluation formula 154 periodically according to update date 158 (or another time counter). Each data collector 160 of a trigger 150 can be an element that collects data in support of trigger evaluation formula 154. Data collector 160 can reference a database record or any addressable data item including local or remote information sources.

Data collector 170 can represent a programmatic object that is able to collect data from various sources, such as asset management system 110 and/or one or more asset discovery systems. Each data collector 170 can include identifier 172, collection status 174, collection mechanism 176, and/or other parameters 178. Identifier 172 can be a unique value (e.g., a number) associated with data collector 170. Collection status 174 can represent the status of the collected data. For example, the collection status 174 can indicate whether a most recent data collection attempt was successful, was a failure, or partially successful. Collection mechanism 176 is a specific mechanism used to collect information. For example, collection mechanism 176 can include a Structured Query Language (SQL) call, a remote invocation of a program or Web service, a URI, and the like. Parameters 178 can represent configurable values used by the data collector 170.

Formula 180 can be an expression, programmatic algorithm, mathematical formula, and the like used within a signature 130 or trigger 150 to calculate a value. Formula 180 helps score a state of an asset 122 to determine whether that asset is derelict or not. Additionally, formula 180 determines the cost or risk of an asset 122. Each instance of formula 180 can include sequence 182, algorithm 184, and return 186. Sequence 182 can be a number associated with the formula 180. Formula 180 can be evaluated in sequence until a value of true is reached. Once reached, formula 180 can stop future evaluations. Sequence 182 can be utilized for dependency relationships and when implementing processing time restrictions/conditions on formula 180. Algorithm 184 can be a mathematical equation, computational function, or set of executable instructions which is/are executed to assist in determining a state of the configuration item 114 or corresponding asset 122, or for determining the cost or risk of an asset 122. Return 186 is a value returned responsive to executing the algorithm 184. For example, for signature evaluation formula 140 or signature status formula 144, the return can be a state of normal, suspect, derelict delete, derelict contain, or retired (i.e., normal or non-normal). Further, for price formula 166 or risk formula 196, the return can include values as discussed below.

Price formula 166 can determine, for example, operational costs, which include the human and environmental costs associated with the asset (e.g., configuration costs, administrative maintenance costs, energy costs, etc.). Price formula 166 can also determine, for example, liability cost, which is a cost associated with undesirable exposure that can manifest itself through the associated asset 122 (e.g., operational cleanup cost after failure, security review costs, maintenance damage cost, etc.). The capability to determine costs in multiple dimensions (e.g., operational costs and liability costs, etc.) helps owners or operators of IT environment 120 to determine the business value of operating particular assets 122.

Risk formula 196 can calculate the potential a given derelict asset has in terms of unintended availability. In particular, risk formula 196 determines how likely a derelict asset is to lead to the loss valued by price formula 166 in at least one dimension. For instance, in one embodiment risk formula 196 can determine the likelihood of a liability cost, while it is assumed that the operational cost is a given (e.g., is already being realized on an ongoing basis, such that a risk determination is not necessary). In another embodiment, risk formula 196 can determine the likelihood of all possible costs.

Utilization of price formula 166 and risk formula 196 can aide in business value determination in several ways. For example, their utilization can help with the prioritization of work orders based on business value (e.g., work orders related to high-cost or high-risk derelict assets can be given a high priority, etc.). Further, their utilization can be a driving factor to determine the technical or business value of having particular assets 122 in a particular data center of IT environment 120. Also, users of assets 122 can learn the business value of assets 122, and understand/appreciate their impact, in addition to owners and operators of IT environment 120. Further still, use of price formula 166 and risk formula 196 can be incorporated into existing risk management systems.

In one embodiment, asset 122 can include a configuration to allow a network port, or set of ports, to be opened and given access to the outside world. Later, the service utilizing asset 122 (i.e., a second asset) is provisioned elsewhere or taken offline for a period of time. However, the port configuration on the VPN has not been removed or contained. As such, the port configuration can be regarded as a derelict asset. Another service (i.e., a third asset) is provisioned and is assigned the same IP address, network configuration, and asset role. Unintentionally, the new service has been assigned an open port, the derelict asset, from the existing configuration.

In such a case, price formula 166 can determine operational costs of the derelict asset. In the case of a port configuration, the operational cost may be essentially zero on an ongoing basis, and nominal (but nonzero) on a termination basis. In particular, the operational cost of the port configuration might be nothing while it continues to exist, and quite low to disable. For instance, the operational cost of disabling the port configuration might equal the dollar value of the time spent commanding the port configuration to be disabled by administrative staff of IT environment 120. Price formula 166 can also determine the liability cost of the derelict asset. In the case of a port configuration, the liability cost is a cost associated with undesirable exposure that can manifest itself through the port configuration. For instance, the liability cost can manifest if a network penetration to the new service (i.e., the third asset unintentionally exposed by the port configuration) by a malicious actor is successful. Such liability costs can include operational cleanup cost after the network penetration, security review costs, and maintenance damage cost. Other liability costs can include fines for breach of data privacy laws, public relations costs, and loss of business goodwill. By capturing costs with price formula 166, derelict assets can be held accountable to any financial, configuration, administration, maintenance or energy costs they might be associated with.

In such a case, risk formula 196 can determine how likely the port configuration is to lead to the loss valued by price formula 166. In the case of a port configuration, the risk can be determined by examining the known set of attack vectors through the particular port configuration, as well as the known vulnerabilities of the new service (i.e., the third asset unintentionally exposed by the port configuration), for example. If the set of attack vectors through the particular port is limited because the port is exposed on an internal network subject to local traffic but not to Internet traffic, the risk is reduced. Further, if the new service is robust against vulnerabilities, or does not have access to sensitive data, the risk is also reduced. If any of these conditions are reversed, the risk will rise. By capturing risks with risk formula 196, derelict assets can be judged for prioritization purposes.

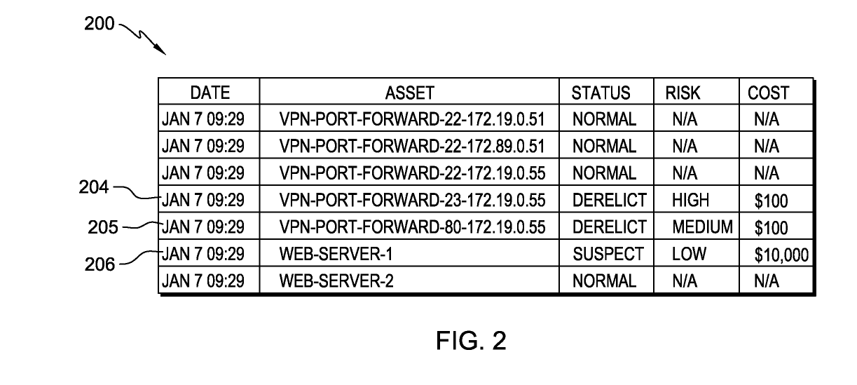

FIG. 2 depicts graphical interface 200 for displaying cost and risk of derelict assets of IT environment 120 in accordance with an embodiment of the present invention. In particular, graphical interface includes numerous records including records 204, 205, and 206. Record 204, displayed in graphical interface 200, includes a date (e.g., the date the record was updated, etc.), the asset “VPN-PORT-FORWARD-23-172.19.0.55,” and status, risk, and cost fields. The status, risk, and cost fields of record 204 indicate that “VPN-PORT-FORWARD-23-172.19.0.55” is a derelict asset having a high risk but a cost of only $100. The risk of the asset could have been determined to be high by risk formula 196 because, for example, the asset is a port configuration that exposes a service with multiple known vulnerabilities to Internet traffic. The cost of the asset could have been determined to be only $100 by price formula 166 because, for example, the exposed service does not have access to sensitive data.

Record 205, displayed in graphical interface 200, is an asset “VPN-PORT-FORWARD-80-172.19.0.55” which is similar to the port configuration referenced in record 204 and discussed above. The asset of record 205 has a slightly lower risk (i.e., medium) and the same cost. The risk of the asset could have been determined to be medium by risk formula 196 because, for example, the asset is a port configuration that exposes a service with only one obscure known vulnerability to Internet traffic. The cost of the asset could have been determined to be only $100 by price formula 166 because, for example, the exposed service does not have implications regarding data privacy laws, public relations costs, or loss of business goodwill.

Record 206, displayed in graphical interface 200, is an asset “WEB-SERVER-1” which is only suspected to be derelict, rather than actually derelict. Nevertheless, although the asset is only suspect, the risk and cost of the asset could still have been determined. In particular, the risk of the asset has been determined to be low by risk formula 196 because, for example, the asset is a hardened web server that has no known vulnerabilities to any kind of network traffic. However, the cost of the asset could have been determined to be quite high (e.g., $10,000, etc.) relative to the derelict assets by price formula 166 because, for example, the web server (e.g., by virtue of the content it serves, etc.) has serious implications regarding data privacy laws, public relations costs, or loss of business goodwill.

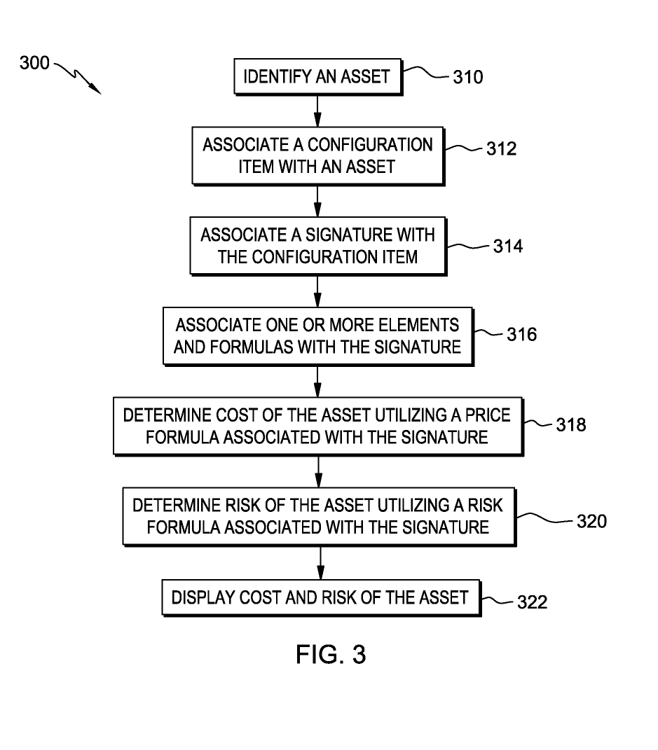

FIG. 3 depicts flowchart 300 illustrating steps followed by asset management system 110 during the determination of the cost and risk of derelict assets of IT environment 120 in accordance with an embodiment of the present invention. In step 310, asset management system 110 identifies an asset 122 of IT environment 120. For example, asset management system 110 can access IT environment 120 via network 111 to make the identification. In step 312, asset management system 110 associates configuration item 114 with asset 122 by, for example, generating configuration item 114 in data store 112. In step 314, asset management system 110 associates signature 130 with configuration item 114. In step 316, asset management system 110 associates one or more elements and formulas with signature 130. For example, asset management system 110 can associate descriptive elements 132, state elements 134, state support elements 136, data gathering elements 138, signature evaluation formula 140, signature status formula 144, cost element 145, and risk element 146 with signature 130. In step 318, asset management system 110 can determine the cost of asset 122 utilizing price formula 166 associated with signature 130. For example, asset management system 110 can make the determination by evaluating price formula 166 of cost element 145. In step 320, asset management system 110 can determine the risk of asset 122 utilizing risk formula 196 associated with signature 130. For example, asset management system 110 can make the determination by evaluating risk formula 196 of risk element 146. In step 322, asset management system 110 can display the cost and risk of asset 122 by, for example, generating and displaying graphical interface 200.

Referring now to FIG. 4, a functional block diagram of a computer system in accordance with an embodiment of the present invention is shown. Computer system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove.

In computer system 400 there is computer 412, which is operational with numerous other general purpose or special purpose computing system environments or configurations. Examples of well-known computing systems, environments, and/or configurations that may be suitable for use with computer 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of asset 122 and asset management system 110 can include or can be implemented as an instance of computer 412.

Computer 412 may be described in the general context of computer system executable instructions, such as program modules, being executed by a computer system. Generally, program modules may include routines, programs, objects, components, logic, data structures, and so on that perform particular tasks or implement particular abstract data types. Computer 412 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 4, computer 412 in computer system 400 is shown in the form of a general-purpose computing device. The components of computer 412 may include, but are not limited to, one or more processors or processing units 416, memory 428, and bus 418 that couples various system components including memory 428 to processing unit 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 412 typically includes a variety of computer system readable media. Such media may be any available media that is accessible by computer 412, and includes both volatile and non-volatile media, and removable and non-removable media.

Memory 428 can include computer system readable media in the form of volatile memory, such as random access memory (RAM) 430 and/or cache 432. Computer 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Program 440, having one or more program modules 442, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. One or more programs within IT environment 120 and asset management system 110 can be implemented as or can be an instance of program 440.

Computer 412 may also communicate with one or more external devices 414 such as a keyboard, a pointing device, etc., as well as display 424; one or more devices that enable a user to interact with computer 412; and/or any devices (e.g., network card, modem, etc.) that enable computer 412 to communicate with one or more other computing devices. Such communication can occur via Input/Output (I/O) interfaces 422. Still yet, computer 412 can communicate with one or more networks such as a local area network (LAN), a general wide area network (WAN), and/or a public network (e.g., the Internet) via network adapter 420. As depicted, network adapter 420 communicates with the other components of computer 412 via bus 418. It should be understood that although not shown, other hardware and/or software components could be used in conjunction with computer 412. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining the cost and risk of assets, the method comprising:
a computer analyzing an asset signature, associated with an asset representing a fundamental structural unit of an information technology environment, to determine that the asset is in a non-normal state;
the computer determining the cost of the asset by evaluating a price formula associated with the asset signature of the asset;
the computer determining the risk of the asset by evaluating a risk formula associated with the asset signature of the asset;
the computer maintaining a configuration item for the asset, indicating the state, the risk, and the cost of the asset.

2. The method of claim 1, wherein the risk and the cost of the asset are used to determine the priority of recovering the asset.

3. The method of claim 1, wherein determining the cost of the asset includes determining an operational cost and a liability cost.

4. The method of claim 1, wherein determining the risk of the asset includes determining a vulnerability of the asset.

5. The method of claim 1, wherein determining that the asset is in a non-normal state includes evaluating a signature evaluation formula and a signature status formula, wherein the signature status formula performs a point in time evaluation of the asset, wherein the signature status formula performs an evaluation of the asset over a time range, and wherein asset state is determined when analyzing the asset signature by combining results of both the signature evaluation formula and the signature status formula.

6. The method of claim 5, wherein the signature evaluation formula and the signature status formula each include a trigger, wherein the trigger represents a way of scoring the asset signature by gathering relevant data to support the formula.

7. The method of claim 6, wherein each trigger comprises at least one trigger point, a trigger evaluation formula, a reset counter, an update date, and at least one data collector.

8. A computer program product for determining the cost and risk of assets, the computer program product comprising:
one or more computer readable tangible storage devices and program instructions stored on at least one of the one or more storage devices, the program instructions comprising:
program instructions to analyze an asset signature, associated with an asset representing a fundamental structural unit of an information technology environment, to determine that the asset is in a non-normal state;
program instructions to determine the cost of the asset by evaluating a price formula associated with the asset signature of the asset;
program instructions to determine the risk of the asset by evaluating a risk formula associated with the asset signature of the asset;
program instructions to maintain a configuration item for the asset, indicating the state, the risk, and the cost of the asset.

9. The computer program product of claim 8, wherein the risk and the cost of the asset are used to determine the priority of recovering the asset.

10. The computer program product of claim 8, wherein determining the cost of the asset includes determining an operational cost and a liability cost.

11. The computer program product of claim 8, wherein determining the risk of the asset includes determining a vulnerability of the asset.

12. The computer program product of claim 8, wherein determining that the asset is in a non-normal state includes evaluating a signature evaluation formula and a signature status formula, wherein the signature status formula performs a point in time evaluation of the asset, wherein the signature status formula performs an evaluation of the asset over a time range, and wherein asset state is determined when analyzing the asset signature by combining results of both the signature evaluation formula and the signature status formula.

13. The computer program product of claim 12, wherein the signature evaluation formula and the signature status formula each include a trigger, wherein the trigger represents a way of scoring the asset signature by gathering relevant data to support the formula.

14. The computer program product of claim 13, wherein each trigger comprises at least one trigger point, a trigger evaluation formula, a reset counter, an update date, and at least one data collector.

15. A system for determining the cost and risk of assets, the system comprising:
one or more processors, one or more computer readable memories, one or more computer readable tangible storage devices, and program instructions stored on at least one of the one or more storage devices for execution by at least one of the one or more processors via at least one of the one or more memories, the program instructions comprising:
program instructions to analyze an asset signature, associated with an asset representing a fundamental structural unit of an information technology environment, to determine that the asset is in a non-normal state;
program instructions to determine the cost of the asset by evaluating a price formula associated with the asset signature of the asset;
program instructions to determine the risk of the asset by evaluating a risk formula associated with the asset signature of the asset;
program instructions to maintain a configuration item for the asset, indicating the state, the risk, and the cost of the asset.

16. The system of claim 15, wherein the risk and the cost of the asset are used to determine the priority of recovering the asset.

17. The system of claim 15, wherein determining the cost of the asset includes determining an operational cost and a liability cost.

18. The system of claim 15, wherein determining the risk of the asset includes determining a vulnerability of the asset.

19. The system of claim 15, wherein determining that the asset is in a non-normal state includes evaluating a signature evaluation formula and a signature status formula, wherein the signature status formula performs a point in time evaluation of the asset, wherein the signature status formula performs an evaluation of the asset over a time range, and wherein asset state is determined when analyzing the asset signature by combining results of both the signature evaluation formula and the signature status formula.

20. The system of claim 19, wherein the signature evaluation formula and the signature status formula each include a trigger, wherein the trigger represents a way of scoring the asset signature by gathering relevant data to support the formula.
